(19) United States
(12) Patent Application Publication
(10) Pub. No.: US 2020/0304002 A1
(43) Pub. Date: Sep. 24, 2020

(54) Permanent Magnet Motor For Electrical Submersible Pump

(71) Applicant: Baker Hughes Oilfield Operations LLC, Houston, TX (US)

(72) Inventor: Arslan Amjad, Claremore, OK (US)

(73) Assignee: Baker Hughes Oilfield Operations LLC, HOUSTON, TX (US)

(21) Appl. No.: 16/825,005

(22) Filed: Mar. 20, 2020

Related U.S. Application Data
(60) Provisional application No. 62/821,528, filed on Mar. 21, 2019.

(51) Int. Cl. H02K 21/02; H02K 5/132; E21B 43/12; F04D 13/08

(52) U.S. Cl. CPC H02K 21/029; F04D 13/08; E21B 43/128; H02K 5/132

(57) ABSTRACT

An electrical submersible pump motor has rotor sections mounted along a length of a shaft to cause rotation of the shaft. Pole magnets are spaced apart from each other and mounted to the shaft. Each of the pole magnets is polarized with a north pole on one of its inner and outer sides and a south pole on the other of its inner and outer sides. An orthogonal magnet is mounted between each of the pole magnets. Each of the orthogonal magnets is polarized with a north pole on one of the its ends and a south pole on the other of its ends.

### CROSS REFERENCE TO RELATED APPLICATION

This application claims priority to provisional application Ser. No. 62/821,528, filed Mar. 21, 2019.

### FIELD OF DISCLOSURE

This disclosure relates to electrical submersible well pumps (ESP), and in particular to a permanent magnet ESP motor having orthogonal magnets mounted between the pole magnets.

### BACKGROUND

ESP's are often used to pump well fluid from hydrocarbon wells. One common type of motor for an ESP is an induction electric motor having stator windings encircling a rotor mounted to a drive shaft. The rotor has a stack of steel laminations with copper rods extending through them. Three-phase power applied to the stator windings induces rotation of the rotor.

Another type uses permanent magnets in the rotor, each providing one pole of the motor, which may have two, four or a different number of poles. Each permanent magnet is an arcuate member having an inner side bonded or otherwise attached to a sleeve mounted to the shaft for rotation and an outer side facing and spaced from the stator by a gap. Each pole magnet has two ends circumferentially spaced apart from each other, such as about 70 degrees in a four-pole motor. Each pole magnet has a north pole on either its inner arcuate side or its outer arcuate side and a south pole on the opposite side. In a four-pole motor, the north poles of two of the pole magnets 180 mechanical degrees from each other are on the outer sides. The south poles of the other two pole magnets are on the inner sides. Non-magnetic spacer bars may be positioned between the juxtaposed ends of adjacent pole magnets.

While permanent magnet ESP motors work well, improvements are desired. For example, some of the improvements could be to reduce thermal stresses in the pole magnets and improve the power factor and output torque.

### SUMMARY

An electrical submersible pump motor comprises a stator having a stack of laminations with windings extending through slots in the laminations, the stator having a bore with a longitudinal axis. A shaft extends through the bore. Rotor sections mounted along a length of the shaft cause rotation of the shaft. Each of the rotor sections comprises a tubular core mounted to the shaft for rotation in unison. Pole magnets are spaced apart from each other and mount to an outer side of the core. Each of the pole magnets has an inner side, an outer side and two pole magnet ends joining the inner and outer sides. Each of the pole magnets is polarized with a north pole on one of the inner and outer sides and a south pole on the other of the inner and outer sides. Orthogonal magnets are also mounted to an outer side of the core. Each of the orthogonal magnets locates between two of the pole magnets. Each of the orthogonal magnets has an inner side, an outer side, and two orthogonal magnet ends joining the inner and outer sides of each of the orthogonal magnets. Each of the orthogonal magnets is polarized with a north pole on one of the orthogonal magnet ends and a south pole on the other of the orthogonal magnet ends.

Each of the orthogonal magnets of a first group has its north pole facing clockwise and its south pole facing counterclockwise. Each of the orthogonal magnets of a second group has its north pole facing counterclockwise and its south pole facing clockwise. The orthogonal magnets of the first group alternate with the orthogonal magnets of the second group.

In one embodiment, each of the orthogonal magnets has magnetic flux lines that are curved in a circumferential direction. In another embodiment, each of the orthogonal magnets has magnetic flux lines that are straight and tangent to the outer side of each of the orthogonal magnets.

### BRIEF DESCRIPTION OF THE DRAWINGS

FIG. 1 is an schematic sectional view of an ESP in accordance with this disclosure.

FIG. 2 is a schematic, partial axial sectional view of a portion of the motor.

FIG. 3 is a transverse sectional view of the motor, taken along the line 3-3 of FIG. 2 and with the housing removed.

FIG. 4 is a top view of the permanent magnets shown in FIG. 3, but with the stator and shaft removed.

FIG. 5 is a an sectional view of the rotor assembly of the motor of FIG. 2, with the shaft removed.

FIG. 6 is a sectional view of the rotor assembly of FIG. 5, taken along the line 6-6 of FIG. 5.

FIG. 7 is a top view of an alternate embodiment of one of the orthogonal magnets shown of FIG. 4.

While the disclosure will be described in connection with one embodiment, it will be understood that it is not intended to limit the disclosure to that embodiment. On the contrary, it is intended to cover all alternatives, modifications, and equivalents, as may be included within the scope of the claims.

### DETAILED DESCRIPTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes plus or minus 5% of the cited magnitude. In an embodiment, usage of the term “substantially” includes plus or minus 5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

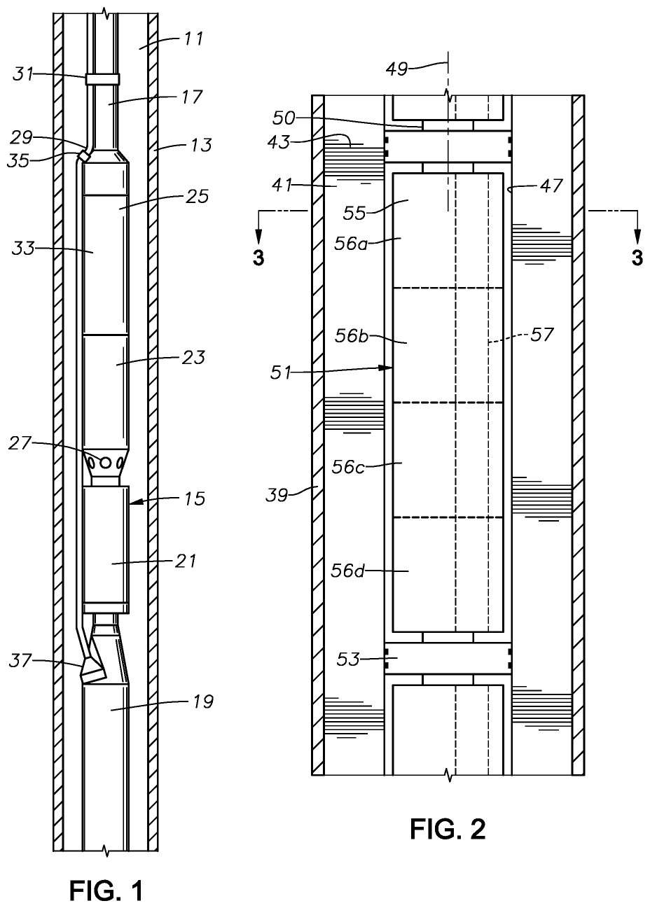

Referring to FIG. 1, a well 11 has casing 13 that is perforated or has other openings to admit well fluid. An electrical submersible pump assembly or ESP 15 is illustrated as being supported on production tubing 17 extending into well 11. Alternately, ESP 15 could be supported by other structure, such as coiled tubing. Although shown installed vertically, ESP 15 could be located within an inclined or horizontal section of well 11. The terms “upper”, “lower” and the like as used herein only for convenience, because ESP 15 can be operated in inclined or horizontal sections of a well. ESP 15 has several modules, including a motor 19, normally a three-phase electrical motor. A motor protector or seal section 21 connects to motor 19 and has components, such as a bladder, for reducing a pressure differential between lubricant in motor 19 and the hydrostatic pressure of well fluid. Seal section 21 may be mounted to an upper end of motor 19 or alternately to a lower end. An optional gas separator 23 connects to the upper end of seal section 21 in this example.

A pump 25 connects to gas separator 23 if one is employed; if a gas separator is not used, pump 25 may connect to seal section 21, as shown, or to motor 19. Pump 25 has a well fluid intake 27 that will be in gas separator 23 if one is used, and if not, at a base of pump 25. Pump 25 is normally a rotary pump, such as a centrifugal or progressing cavity pump, but it could be a reciprocating pump. The connections between the modules of ESP 15 are shown as bolted flanges, but they could be threaded connections.

A power cable 29 extends from a wellhead (not shown) alongside tubing 17 for supplying power to motor 19. Spaced apart clamps 31 (only one shown) secure power cable 29 to production tubing 17. A motor lead 33, which may be considered to be a lower part of power cable 29, connects to a lower end of power cable 29 by a splice 35 in this example. Motor lead 33 extends alongside ESP 15 and has an electrical connector 37 on its lower end that secures to a receptacle at the upper end of motor 19. Splice 35 is illustrated at the upper end of pump 25, but it could be a considerable distance above pump 25.

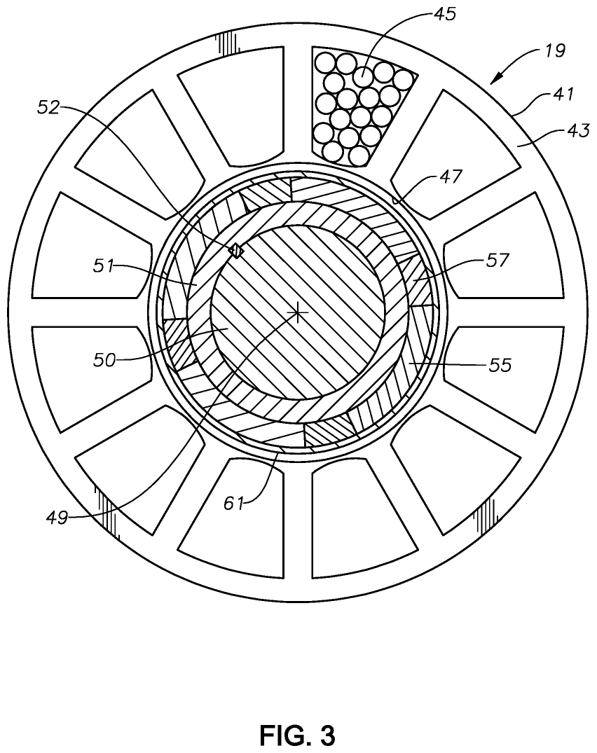

Referring to FIG. 2, motor 19 has a housing 39 containing a non-rotating stator 41. Stator 41 is conventional, having a stack of thin steel discs or laminations 43. Windings 45 (shown in one of the slots in FIG. 3) extend through slots in laminations 43. Stator 41 has a cylindrical central bore 47 with a longitudinal axis 49. A rotatable drive shaft 50 extends through bore 47 on axis 49 for driving pump 25 (FIG. 1).

Rotor sections 51 are mounted to shaft 50 by a key arrangement 52 for causing shaft 50 to rotate. Rotor sections 51 are positioned along the length of shaft 50 and spaced apart from each other a short distance. A radial bearing 53 locates between adjacent ends of the rotor sections 51. Bearings 53 frictionally engage the inner diameter of stator 41 to prevent their rotation.

Each rotor section 51 has a number of permanent pole magnets 55 mounted circumferentially around shaft 50. Pole magnets 55 are indicated by dotted lines in FIG. 2, and may be located in segments, each segment having an array of pole magnets 55 spaced around shaft 50. In this example, there are four segments 56a, 56b, 56c and 56d, each segment containing pole magnets 55 encircling shaft 50. The array of four segments 56a, 56b, 56c and 56d extends approximately a full length of each rotor section. The lower ends of the pole magnets 55 in each segment 56a, 56b and 56c may abut the upper ends of the pole magnets 55 in the next lower segment. There are at least two pole magnets 55 in each segment 56a, 56b, 56c and 56d, and they are separated from adjacent pole magnets 55 by orthogonal permanent magnets 57. The orthogonal magnets 57 in each segment 56a, 56b, 56c and 56d have the same axial dimension as the pole magnets 55 in the same segment.

Referring to FIG. 3, in this example, there are four pole magnets 55 in each segment 56a, 56b, 56c and 56d, but other numbers are feasible, such as two, six or other numbers. There are also four orthogonal magnets 57 in each segment 56a, 56b, 56c and 56d, each located between two adjacent pole magnets 55. In this example, pole magnets 55 and orthogonal magnets 57 are mounted to the outer surface of an inner sleeve or tubular core 59 that is keyed or affixed to shaft 50 for rotating shaft 50. Pole magnets 55 and orthogonal magnets 57 may attach to inner sleeve 59 in various manners, such as by epoxy or an adhesive. Optionally, a protective outer sleeve 61 encloses the array of magnets 55, 57 and rotates with each rotor section 51. Shaft 50 and inner sleeve 59 are normally of a magnetically permeable material, such as a steel. Outer sleeve 61 is non-magnetic and may be of different materials. An annular gap exists between outer sleeve 61 and the inner diameter of stator 41.

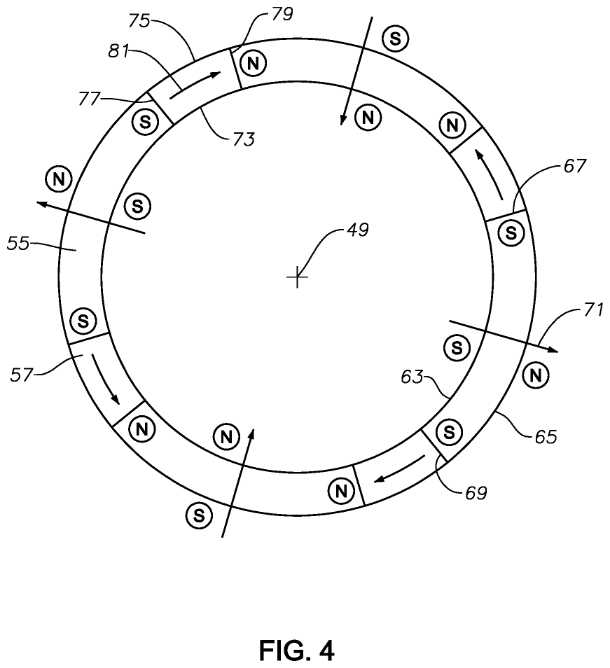

Referring to FIG. 4, each pole magnet 55 has an arcuate inner side 63 and an arcuate outer side 65, and each side 63, 65 has a radius with a center point on axis 49. Each pole magnet has circumferential ends 67, 69 that join inner and outer sides 63, 65. In this embodiment, each end 67, 69 is flat and located on a radial plane of axis 50. A circumferential length between ends 67, 69 is the same for each of the pole magnets 55. This circumferential length may vary and is illustrated to be equivalent to about 70 degrees. Each pole magnet 55 has a south pole on one of its inner and outer sides 63, 65 and a north pole on the opposite side. The south and north poles are indicated by the letters “S” and “N” in FIG. 4. The four-pole design alternates the north and south poles between adjacent pole magnets 55. Two of the pole magnets 55 have the south pole on the inner side 63 and two on the outer side 65. The two pole magnets 55 with the south pole on the inner sides 63 are 180 mechanical degrees from each other. Similarly, the two pole magnets 55 with the south pole on the outer sides 65 are 180 degrees from each other.

Orthogonal magnets 57 are also curved, having arcuate inner sides 73 and arcuate outer sides 75. Flat circumferential ends 77, 79 are located in radial planes of axis 49 and join inner and outer sides 73, 75. Each orthogonal magnet 57 has the same radial width between inner and outer sides 73, 75 as pole magnets 55, resulting in a constant outer diameter for the array of magnets 55, 57. The circumferential length of each orthogonal magnet 57 is less than the circumferential lengths of pole magnets 55. In this embodiment, the circumferential length of each orthogonal magnet 57 is equivalent to about 20 degrees.

In the embodiment shown in FIG. 4, each orthogonal magnet 57 is polarized in an orthogonal manner with a south pole on one end 77, 79 and a north pole on the opposite end. The flux lines emanated from each north and south pole are normal to the flat ends of faces 77, 79. This polarization creates a magnetic flux 81 that curves in a circumferential direction, from one end 77, 79 through the opposite end 77, 79.

Each orthogonal magnet 57 has a polarity opposite to the orthogonal magnet 57 closest to it. For example, the orthogonal magnets 57 at about 30 and 210 degrees in the drawing have magnet flux 81 directed in a counterclockwise rotational direction, and the orthogonal magnets 57 at 120 and 300 degrees have magnetic flux 81 directed in a clockwise rotational direction.

Each orthogonal magnet 57 completely fills the space between adjacent ones of the pole magnets 55. Each orthogonal magnet end 77, 79 is flush with and abuts one of the pole magnet ends 67, 79, creating a continuous annular shape for the magnetic array.

Orthogonal magnets 57 may be of the same material as pole magnets 55, typically a rare earth magnetic material. The same or similar material results in orthogonal magnets 57 having the same coefficient of thermal expansion as pole magnets 55, avoiding thermal stresses that occur as motor 19 heats.

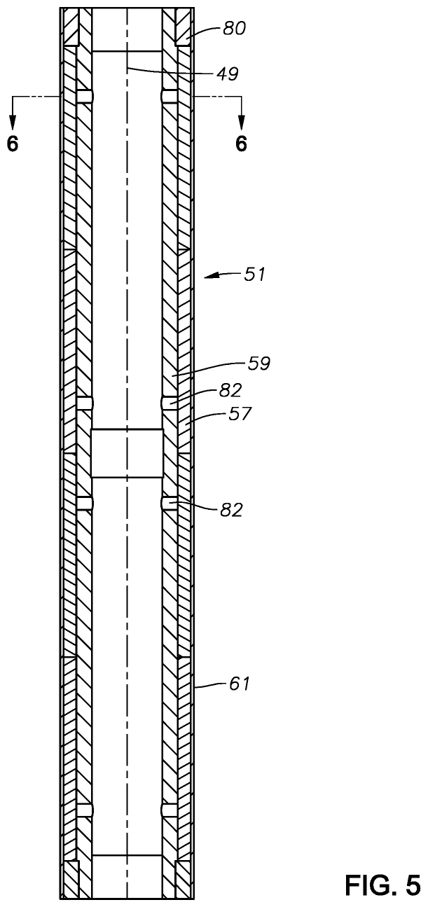

FIG. 5 illustrates rotor section 51 in an axial section with shaft 50 (FIG. 3) removed. End rings 80 attach to the upper and lower ends of inner sleeve 59 to secure orthogonal magnets 57 and pole magnets 55 (FIG. 4) to the outer side of inner sleeve 59. Inner sleeve 59 may have a number of apertures 82 through its side wall to facilitate in assembling magnets 55 and 57.

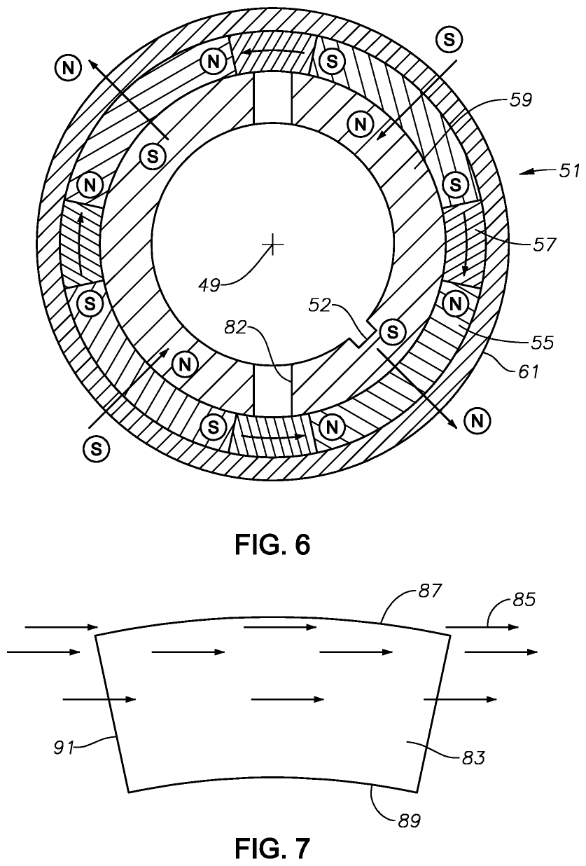

FIG. 6 is an assembly view similar to FIG. 4, but showing that magnets 55, 57 are located between inner sleeve 59 and outer sleeve 61. FIG. 6 also shows rotor section 51 with shaft 50 removed.

During operation, three phase AC power will be supplied to stator windings 45. A variable speed drive at the surface of the well may vary the frequency of the power for startup and other reasons. The current in windings 45 results in magnetic flux being created that revolves around stator 41. The revolving electromagnetic field interacts with the magnetic flux 71 of pole magnets 55, causing rotor sections 51 and shaft 50 to rotate. Orthogonal magnets 57 increase the overall magnetic flux 71 linked with windings 45 by redirecting or adjusting the magnetic flux 71 near pole magnet ends 67, 69. The redirection of magnetic flux 71 results in improved torque capacity and a higher power factor for motor 19.

In the alternate embodiment shown in FIG. 7, orthogonal magnet 83 may be machined from a rectangular magnetized block of magnetic material. Orthogonal magnets 83 also have flux lines 85 that emanate in rotational directions. However, flux lines 85 are generally straight, rather than curved circumferentially like flux line 81 of orthogonal magnets 57 (FIG. 4). Flux lines 85 emanate generally tangential to the curvature of outer side 87 or inner side 89 at the center point between the flat circumferential ends 91. Flux lines 85 do not emanate normal to flat ends 87. Rather, flux lines 85 emanate at an angle other than 90 degrees relative to flat ends 87. Otherwise, orthogonal magnets 83 are the same as orthogonal magnets 57.

The present disclosure described herein, therefore, is well adapted to carry out the objects and attain the ends and advantages mentioned, as well as others inherent therein. While only two embodiments of the disclosure have been given for purposes of disclosure, numerous changes exist in the details of procedures for accomplishing the desired results. These and other similar modifications will readily suggest themselves to those skilled in the art, and are intended to be encompassed within the scope of the appended claims.

1. An electrical submersible pump motor, comprising:
a stator having a stack of laminations with windings extending through slots in the laminations, the stator having a bore with a longitudinal axis;
a shaft extending through the bore;
rotor sections mounted along a length of the shaft for rotating the shaft, each of the rotor sections comprising:
a tubular core mounted to the shaft for rotation in unison;
a plurality of pole magnets spaced apart from each other and mounted to an outer side of the core, each of the pole magnets having an inner side, an outer side and two pole magnet ends joining the inner and outer sides, each of the pole magnets being polarized with a north pole on one of the inner and outer sides and a south pole on the other of the inner and outer sides; and
a plurality of orthogonal magnets mounted to an outer side of the core, each of the orthogonal magnets being between two of the pole magnets, each of the orthogonal magnets having an inner side, an outer side, and two orthogonal magnet ends joining the inner and outer sides of each of the orthogonal magnets, each of the orthogonal magnets being polarized with a north pole on one of the orthogonal magnet ends and a south pole on the other of the orthogonal magnet ends.

2. The motor according to claim 1, wherein:
each of the orthogonal magnets of a first group has its north pole facing clockwise and its south pole facing counterclockwise, and each of the orthogonal magnets of a second group has its north poles facing counterclockwise and its south pole facing clockwise; and
the orthogonal magnets of the first group alternate with the orthogonal magnets of the second group.

3. The motor according to claim 1, wherein:
each of the orthogonal magnets has magnetic flux lines that are curved in a circumferential direction.

4. The motor according to claim 1, wherein each of the orthogonal magnets has magnetic flux lines that are straight and tangent to the outer side of each of the orthogonal magnets.

5. An electrical submersible pump motor, comprising:
a stator having a stack of laminations with windings extending through slots in the laminations, the stator having a bore with a longitudinal axis;
a shaft extending through the bore;
rotor sections mounted along a length of the shaft for rotating the shaft, each of the rotor sections comprising:
a plurality of pole magnets, each having an arcuate inner side, an arcuate outer side and two ends spaced circumferentially apart from each other and facing in opposite directions, each of the pole magnets being polarized to emanate magnetic flux in a direction normal to the inner and outer sides of each of the pole magnets; and
a plurality of orthogonal magnets, each mounted between the ends of adjacent ones of the pole magnets, each of the orthogonal magnets having an arcuate inner side, an arcuate outer side, and two ends spaced circumferentially apart from each other, one of the ends of each of the orthogonal magnets facing one of the ends of one of the pole magnets, and the other of the ends of each of the orthogonal magnets facing one of the ends of another of the pole magnets, each of the orthogonal magnets being polarized to emanate magnetic flux in a rotational direction.

6. The motor according to claim 5, wherein:
each of the pole magnets has a circumferential length from one of its ends to the other of its ends that is greater than a circumferential length of each of the orthogonal magnets.

7. The motor according to claim 5, wherein:
each of the ends of each of the orthogonal magnets is in abutment with one of the ends of one of the pole magnets.

8. The motor according to claim 5, wherein the orthogonal magnets are formed of a same material as the pole magnets.

9. The motor according to claim 5, wherein:
one of the inner side and the outer side of each of the pole magnets is a south pole and the other a north pole; and
one of the ends of each of the orthogonal magnets is a south pole and the other a north pole.

10. The motor according to claim 5, wherein:
the magnetic flux of one of the orthogonal magnets is in a clockwise rotational direction; and
the magnetic flux of another one of the orthogonal magnets is in a counterclockwise rotational direction.

11. The motor according to claim 5, wherein each of the orthogonal magnets has magnetic flux lines that are curved in a circumferential direction.

12. The motor according to claim 5, wherein each of the orthogonal magnets has magnetic flux lines that are straight and tangent to the outer side of each of the orthogonal magnets.

13. The motor according to claim 5, wherein each of the ends of each of the orthogonal magnets is in a radial plane of the axis.

14. An electrical submersible pump motor, comprising:
a stator having a stack of laminations with windings extending through slots in the laminations, the stator having a bore with a longitudinal axis;
a shaft extending through the bore;
rotor sections mounted along a length of the shaft for rotating the shaft, each of the rotor sections comprising:
a tubular core mounted to the shaft for rotation in unison;
a plurality of pole magnets spaced apart from each other and secured to an outer side of the core, each of the pole magnets having an arcuate inner side, an arcuate outer side and two pole magnet ends, each of the pole magnets being polarized with a north pole on one of the inner and outer sides and a south pole on the other of the inner and outer sides; and
a plurality of orthogonal magnets secured to on an outer side of the core, each of the orthogonal magnets being between two of the pole magnets, each of the orthogonal magnets having an arcuate inner side, an arcuate outer side, and two orthogonal magnet ends spaced circumferentially apart from each other, each of the orthogonal magnet ends of each of the orthogonal magnets being in abutment with one of the pole magnet ends of one of the pole magnets, each of the orthogonal magnets being polarized with a north pole on one of the orthogonal magnet ends and a south pole on the other of the orthogonal magnet ends.

15. The motor according to claim 14, wherein:
each of the pole magnets has a circumferential dimension between the pole magnet ends that is greater than a circumferential dimension between the orthogonal magnet ends of each of the orthogonal magnets.

16. The motor according to claim 14, wherein:
each of the orthogonal magnets of a first group has its north pole facing clockwise and its south pole facing counterclockwise, and each of the orthogonal magnets of a second group has its north poles facing counterclockwise and its south pole facing clockwise; and
each of the orthogonal magnets of the first group alternate with each of the orthogonal magnets of the second group.

17. The motor according to claim 14, wherein:
each of the orthogonal magnets has magnetic flux lines that are curved in a circumferential direction.

18. The motor according to claim 14, wherein each of the orthogonal magnets has magnetic flux lines that are straight and tangent to the outer side of each of the orthogonal magnets.

19. The motor according to claim 14, wherein each of the orthogonal magnet ends of each of the orthogonal magnets is in a radial plane of the axis.

20. The motor according to claim 14, further comprising a sleeve enclosing the outer sides of the pole magnets and the orthogonal magnets.
